(19) United States
(12) Patent Application Publication
(10) Pub. No.: US 2014/0170309 A1
(43) Pub. Date: Jun. 19, 2014

(54) Solvent Alloying of Cellulose Esters to Modify Thickness Retardation of LCD Films

(71) Applicant: Eastman Chemical Company, Kingsport, TN (US)

(72) Inventor: Darryl Aubrey Godfrey, Gray, TN (US)

(73) Assignee: Eastman Chemical Company, Kingsport, TN (US)

(21) Appl. No.: 14/084,936

(22) Filed: Nov. 20, 2013

Related U.S. Application Data
(60) Provisional application No. 61/737,962, filed on Dec. 17, 2012.

(51) Int. Cl. G02B 1/10

(52) U.S. Cl. CPC G02B 1/10
USPC 427/162; 252/582

(57) ABSTRACT

The invention relates to miscible blends of cellulose acylates, films made therefrom and methods of making the miscible blends of cellulose acylates and films made therefrom.

### CROSS-REFERENCES TO RELATED APPLICATIONS

This application claims priority under 35 U.S.C. §119(e) to: U.S. Provisional Application Ser. No. 61/737,962 filed on Dec. 17, 2012, which is hereby incorporated by this reference in its entirety.

### FIELD OF THE INVENTION

This invention pertains to cellulose ester blends, films made from the cellulose ester blends and methods for making the blends and the films. More particularly, this invention pertains to miscible cellulose ester blends, optical films made from the miscible cellulose ester blends and methods of making the films and blends.

### BACKGROUND OF THE INVENTION

Thin film transistor (TFT) liquid crystal displays (LCD) utilize solvent cast cellulose ester films for multiple functions. Cellulose triacetate (CTA) is typically used in protective film for polarizers, while cellulose diacetate (CDA), cellulose acetate propionate (CAP), and cellulose acetate butyrate (CAB) are typically employed in compensation films, with CAP and CAB being preferred on the basis of the optical properties. The compensation films provide wide viewing angle to displays. Because LCD is a transmissive technology, only about 5-6% of the light generated by the backlight exits the display, while the remainder is dissipated as heat. Some light components are slowed or retarded as they pass through, and wide viewing angle of the display is compromised unless retardation or compensation films are utilized. In order to provide optimum viewing angle for an LCD display, it is necessary to use another film with a thickness retardation (Rₜₕ) and planar retardation (Rₑ) that exactly reverses the Rₜₕ and Rₑ of the CTA protective film and the liquid crystal compound. Current TFT LCD panels tend to have one compensation film on each polarizer arranged so that each compensation film is adjacent to the TFT. Having a CTA film with higher glass transition temperature and moisture absorption than does the CAP or CAB compensation film, on the other side of the polyvinyl alcohol polarizer can cause unequal stresses on the polarizer assembly. If dimensional distortion is caused by high temperature and humidity, then light passing through the films will be affected, and the image will be degraded. If CTA or CDA and CAP or CAB could be mixed in an appropriate solvent system, a film could be cast that would be an alloy. Such alloyed films could be used as either protective or compensation films.

The trend in vertical alignment wide view (VA WV) compensation films is away from CAB and CAP to cellulose diacetate (CDA), cyclic olefin polymer (COP), cyclic olefin copolymer (COC) or CTA/CDA/CTA laminates because of lower cost. However, CDA absorbs more water at a given relative humidity than does CAP. Higher water level acts like a plasticizer, lowers glass transition temperature (Tg) causes dimensional instability in the film, and results in larger than desired changes in thickness direction (through-plane direction) retardation, denoted Rth, that can affect viewing angle of the LCD image and cause color shift. Experimentation has shown that cellulose esters become more hydrophobic as longer chain acyl groups such as propionyl or butyryl replace some of the acetyl groups. However, prior attempts to make films from blends of cellulose acetates and mixed cellulose acylates produced low transparency, high haze films. There is a need for less expensive optical films having the optical compensation properties of CAP or CAB for use in the LCD industry.

### BRIEF SUMMARY OF THE INVENTION

It has been unexpectedly discovered that cellulose acylates can be mixed in an appropriate solvent system and cast to form a miscible film or alloy with high transparency and low haze.

One embodiment of the present invention provides a blend comprising
a first cellulose acylate having a first total Hansen solubility parameter and a first number average molecular weight,
a second cellulose acylate having a second total Hansen solubility parameter and a second number average molecular weight,

wherein the composition is a miscible blend,

wherein the first and second total Hansen solubility parameters differ by no more than 0.35 MPa^{0.5},

wherein the first and second number average molecular weights range from about 15,000 to about 40,500 g/mole, and

wherein at least one of the cellulose acylates comprises a mixed cellulose ester.

One embodiment of the present invention provides a film comprising a blend comprising:
a first cellulose acylate having a first total Hansen solubility parameter and a first number average molecular weight,
a second cellulose acylate having a second total Hansen solubility parameter and a second number average molecular weight,

wherein the composition is a miscible blend,

wherein the first and second total Hansen solubility parameters differ by no more than 0.35 MPa^{0.5},

wherein the first and second number average molecular weights range from about 15,000 to about 40,500 g/mole, and

wherein at least one of the cellulose acylates comprises a mixed cellulose ester.

One embodiment of the present invention provides a method of making a film, the method comprising:
dissolving a cellulose acylate having a first total Hansen solubility parameter and a first number average molecular weight, and a second cellulose acylate having a second total Hansen solubility parameter and a second number average molecular weight, in a solvent to form a dope,
casting the dope onto a surface, and
drying the dope to form a film,
wherein the film is a miscible blend of the first and second cellulose acylates,

wherein the first and second total Hansen solubility parameters differ by no more than 0.35 MPa^{0.5}, and

wherein the first and second number average molecular weights range from about 15,000 to about 40,500 g/mole.

In all embodiments of the present invention, the acylate comprises residues of a carboxylic acid having from 1 to 20 carbon atoms.

In certain embodiments of the present invention, the acylate of the first and second cellulose acylates independently comprises residues of acetic acid, propionic acid, butyric acid or mixtures thereof.

In certain embodiments of the present invention, the acylate of the first and second cellulose acylates independently comprises residues of acetic acid, propionic acid, butyric acid or mixtures thereof, wherein the acylate of the first and second acylates are different.

### BRIEF DESCRIPTION OF THE DRAWINGS

FIG. 1 is a graph of the optical properties of films of blends of CTA and CAP 14 based on the data in Table 2.

FIG. 2 is a graph of the optical properties of films of blends of CDA and CAP 16 based on the data in Table 3.

FIG. 3 is a graph of water absorption of CDA and CAP 16 alloys.

FIG. 4 is a graph of the optical properties of films of blends of CDA and CAB 10 alloys.

FIG. 5 is a graph of water absorption of CDA and CAB 10 alloys.

FIG. 6 is a contour plot of the Rth versus the ratio of methylene chloride and methanol in the solvent based on the data in Table 4.

FIG. 7 is a contour plot of the Rth versus the ratio of methylene chloride and methanol in the solvent based on the data in Table 5.

FIG. 8 is a contour plot of the Rth versus the ratio of methylene chloride, methanol and butanol in the solvent based on the data in Table 6.

FIG. 9 is a contour plot of the Rth versus the ratio of methylene chloride, methanol and butanol in the solvent based on the data in Table 7.

### DETAILED DESCRIPTION

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, each numerical parameter should at least be construed in light of the number of reported significant digits and by applying ordinary rounding techniques. Further, the ranges stated in this disclosure and the claims are intended to include the entire range specifically and not just the endpoint(s). For example, a range stated to be 0 to 10 is intended to disclose all whole numbers between 0 and 10 such as, for example 1, 2, 3, 4, etc., all fractional numbers between 0 and 10, for example 1.5, 2.3, 4.57, 6.1113, etc., and the endpoints 0 and 10. Also, a range associated with chemical substituent groups such as, for example, “C1 to C5 hydrocarbons,” is intended to specifically include and disclose C1 and C5 hydrocarbons as well as C2, C3, and C4 hydrocarbons.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

As used in the specification and the claims, the singular forms “a,” “an” and “the” include their plural referents unless the context clearly dictates otherwise. For example, reference to a “promoter,” or a “reactor” is intended to include the one or more promoters or reactors. References to a composition or process containing or including “an” ingredient or “a” step is intended to include other ingredients or other steps, respectively, in addition to the one named.

The terms “containing” or “including,” are synonymous with the term “comprising,” and are intended to mean that at least the named compound, element, particle, or method step, etc., is present in the composition or article or method, but does not exclude the presence of other compounds, catalysts, materials, particles, method steps, etc., even if the other such compounds, material, particles, method steps, etc., have the same function as what is named, unless expressly excluded in the claims.

Solvent

The solvent is not critical and may be any solvent capable of dissolving the cellulose acylates to form a dope. Typical solvents include methylene chloride, methanol and mixtures thereof. One typical solvent mixture includes a 90/10 (by weight) mixture of methylene chloride and methanol. Other typical solvents include ethanol, n-butanol, iso-butanol, iso-propanol and mixtures thereof. Other solvent mixtures include mixtures of methylene chloride and methanol with one or more of ethanol, n-butanol, iso-butanol, iso-propanol and mixtures thereof.

Other possible organic solvents are preferably selected from ethers having 3-12 carbon atoms, esters having 3-12 carbon atoms, ketones having 3-12 carbon atoms and halogenated hydrocarbons having 1-6 carbon atoms. The ethers, the ketones and the esters may have a cyclic structure. Compounds having two or more functional groups of ethers, esters and ketones (i.e., —O—, —CO— and —COO—) are also suitable as the organic solvent, and they may have any other functional group such as an alcoholic hydroxyl group. In cases where the organic solvent has two or more functional groups, the number of the carbon atoms constituting them may fall within a range of the number of carbon atoms that constitute the compound having any of those functional groups.

Solvent Casting

Solvent casting equipment can consist of a casting drum or a casting belt. Casting belts are more common and typically provide better thickness control and stretching capability for films less than 60 microns thick.

Cellulose Esters

The cellulose esters of the present invention are cellulose acetates and mixed cellulose esters. Cellulose acetates have only unsubstituted hydroxyl groups and residues of acetic acid as the acylate. Typical mixed cellulose esters are based for example, on acetyl, propionyl, and/or butyryl, but longer chain carboxylic acids can also be used. In one embodiment, the cellulose ester is a blend of a cellulose acetate and a mixed cellulose ester. In one embodiment, the cellulose ester is a blend of two or more mixed cellulose esters. In another embodiment, the cellulose ester is a blend of two or more esters chosen from cellulose propionates, cellulose butyrates, cellulose acetate propionates (CAP), cellulose acetate butyrates (CAB), cellulose acetate propionate butyrates (CAPB), and cellulose acetate esters. In another embodiment, the cellulose ester is a mixed cellulose ester of acetate and comprises at least one ester residue of an acid chain having more than 4 carbon atoms, such as, for example, pentonoyl or hexanoyl. Such higher acid chain ester residues may include, but are not limited to, for example acid chains esters with 5, 6, 7, 8, 9, 10, 11, and 12, carbon atoms. They may also include acid chains esters with more than 12 carbon atoms. In one embodiment, the acylate comprises residues of a carboxylic acid having from 1 to 20 carbon atoms. In another embodiment of the invention, the mixed cellulose acetate ester that comprises at least one ester residue of an acid chain having more than 4 carbon atoms may also comprise propionyl and/or butyryl groups.

The terms “cellulose ester” and “cellulose acylate” are used interchangeably in this application. The cellulose acylates of the present invention have ester residues formed by reaction of a carboxylic acid, or carboxylic acid equivalents, including but not limited to anhydrides, esters and acid chlorides, with hydroxyl groups on the cellulose backbone. The cellulose acylates of the present invention do not include carboxyalkylcellulose esters in which the ester is connected to the cellulose backbone via a carbon-carbon bond.

Film Stretching

If desired, the film can be stretched in the MD direction by, for example, traditional drafting or combined compression/drawing type drafters. Stretching in the TD is typically performed by tentering. Likewise, a combination of MD and TD stretching can be used if desired. Stretching is usually applied to impart a specific birefringence to the film for use in, for example, compensation films. Actual stretching conditions and configurations are well known in the art. For example, film stretching in multiple directions can be simultaneous or sequential depending on the equipment available. Most stretching operations involve stretch ratios of 1.1 to 5× in one or more directions (although this can vary with material). Furthermore, most stretching also involves a follow up annealing or “heatsetting” step to further condition the material.

Optical Properties

Optical retardations Re and Rth of the films were measured using a Woollam ellipsometer at a wavelength of 633 nm. For film thicknesses that were different from 60 microns, the Rth values were also normalized to a 60 micron equivalent thickness based on the fact that Rth is thickness dependent. This normalized Rth is denoted as “R60,” to differentiate it from the measured Rₜₕ, and R60 is calculated as

R60=60*Rₜₕ/d

where d is the actual film thickness in microns.

Retardation is a direct measure of the relative phase shift between the two orthogonal optical waves and is typically reported in units of nanometers (nm). Rₜₕ is the retardation value measured in the thickness direction of the film. Note that the definition of Rₜₕ varies with some authors particularly with regard to the +/− sign.

As an observer looks through a film, the refractive index through the thickness of the film is denoted n_{Z}, while the refractive indices in the plane of the film are n_{X} for the width (transverse direction (TD)) and n_{Y} for the length (machine direction (MD)). Rₜₕ or thickness retardation and Rₑ or planar retardation are defined as follows:

Rₑ=(nₓ−n_{y})d

Rₜₕ=(nz−((nx+ny)/2))d

Solubility Parameter

In all embodiments of the present invention, the different cellulose acylates in a miscible blend have total Hansen solubility parameters that have a difference of less than or equal to 0.35 MPa^{0.5}. Typical calculated values of total Hansen solubility parameter for various cellulose acylates are shown in the Table 1.

Hansen solubility parameters were originally developed as a way of predicting if a material will dissolve in a solvent to form a solution. Each compound is given three Hansen parameters measured in MPa^{0.5}.

δ_{d} is the energy from dispersion forces between molecules.

δₚ is the energy from polarity forces between molecules.

δₕ is the energy from hydrogen bonds between molecules.

Total Hansen solubility parameter (THSP) of a compound is the square root of the sum of the squares of the dispersion, polarity, and hydrogen bonding parameters. The method for determining the Hansen solubility parameters in this work is based on data from: Properties of Polymers: Their Estimation and Correlation with Chemical Structure, by D. W. Van Krevelen and P. J. Hoftyzer, Elsevier Scientific Publishing Company: New York, 1976. Additional data from Coleman et al. Polymer (1990) Vol 31, 1187-1203 was also used.

Solvent alloying of CTA (17.72 SP) and CAP 14 (18.07 SP) demonstrates that cellulose esters with a total Hansen solubility parameter difference of 0.35 MPa^{0.5} can be solvent alloyed to make optical quality films. There also appears to be a molecular weight effect when cellulose esters are alloyed in this manner. When CDA (18.62 SP) was blended with CAB 11 (18.72 SP) the films were hazy. When CDA (18.62 SP) was mixed with CAB 10 (18.67 SP) very clear films were obtained. As discussed below, this indicates that the number average molecular weights of the cellulose esters in the blends must not be too widely different in order that high transparency results. While not wishing to be bound by any theory, it is believed that for the films to high transparency, i.e., low haze, the blend should have uniform distribution of each component, and each should have molecular weight high enough to be in the chain entanglement region.

TABLE 1

| | | | | | Total Sol. |
|---|---|---|---|---|---|
| Sample | DSAc | DSPr | DSBu | DSOH | Parameter |
| CDA | 2.49 | 0 | 0 | 0.51 | 18.62 |
| CTA | 2.86 | 0 | 0 | 0.14 | 17.72 |
| CAB 1 | 0.33 | 0 | 2.54 | 0.13 | 17.21 |
| CAB 2 | 0.16 | 0 | 2.54 | 0.30 | 17.50 |
| CAB 3 | 1.30 | 0 | 1.46 | 0.24 | 17.58 |
| CAB 4 | 0.24 | 0 | 2.39 | 0.37 | 17.65 |
| CAB 5 | 2.05 | 0 | 0.75 | 0.20 | 17.65 |
| CAB 6 | 0.12 | 0 | 2.50 | 0.38 | 17.65 |
| CAB 7 | 2.06 | 0 | 0.74 | 0.20 | 17.66 |
| CAB 8 | 1.01 | 0 | 1.68 | 0.31 | 17.67 |
| CAB 9 | 1.00 | 0 | 1.67 | 0.33 | 17.71 |
| CAB 10 | 2.24 | 0 | 0.20 | 0.56 | 18.67 |
| CAB 11 | 0.14 | 0 | 1.99 | 0.87 | 18.72 |
| CAP 1 | 2.15 | 0.80 | 0 | 0.05 | 17.41 |
| CAP 2 | 1.72 | 1.20 | 0 | 0.08 | 17.43 |
| CAP 3 | 1.47 | 1.44 | 0 | 0.09 | 17.43 |
| CAP 4 | 1.73 | 1.12 | 0 | 0.15 | 17.59 |
| CAP 5 | 0.10 | 2.64 | 0 | 0.26 | 17.65 |
| CAP 6 | 0.10 | 2.64 | 0 | 0.26 | 17.65 |
| CAP 7 | 0.07 | 2.62 | 0 | 0.31 | 17.75 |
| CAP 8 | 0.07 | 2.62 | 0 | 0.31 | 17.75 |
| CAP 9 | 0.18 | 2.50 | 0 | 0.32 | 17.79 |
| CAP 10 | 0.49 | 2.20 | 0 | 0.31 | 17.80 |
| CAP 11 | 2.08 | 0.67 | 0 | 0.25 | 17.87 |
| CAP 12 | 2.08 | 0.67 | 0 | 0.25 | 17.87 |
| CAP 13 | 0.18 | 2.40 | 0 | 0.42 | 18.01 |
| CAP 14 | 1.92 | 0.74 | 0 | 0.34 | 18.07 |
| CAP 15 | 2.00 | 0.60 | 0 | 0.40 | 18.23 |
| CAP 16 | 1.58 | 0.88 | 0 | 0.54 | 18.52 |
| CAP 17 | 1.30 | 1.10 | 0 | 0.60 | 18.62 |
| CAP 18 | 0.04 | 2.09 | 0 | 0.87 | 19.07 |
| CAP 19 | 0.17 | 1.70 | 0 | 1.13 | 19.82 |

Molecular Weight

Molecular weights were determined using gel permeation chromatography. Methylene chloride was used as the mobile phase. The standard deviation was 2.90% for weight average molecular weight measurements. The method for determining molecular weights was Gel Permeation Chromatography (GPC) calibrated with narrow distribution polystyrene standards, from Polymer Laboratories, ranging in molecular weight from about 162 to about 3,220,000. The solvent used for CDA, CAP, and CAB was 10 mL tetrahydrofuran with 0.1 mL toluene. 25 milligrams of the CDA, CAP and CAP were dissolved in the solvent. The solvent used for CTA was 10 mL dichloromethane with 0.1 mL toluene. 50 milligrams of the CTA was dissolved in the solvent. The samples of CTA were run on an Agilent Technologies Infinity 1260 gel permeation chromatograph with a 1100 series heater to maintain the columns at 28° C. The samples of CDA, CAB and CAP were run on an Agilent Technologies Infinity 1260 gel permeation chromatograph with a 1100 series heater to maintain the columns at 30° C. The chromatograph was equipped with, as a guard column, an Agilent PLgel 5 micron, 50×7.5 mm column. The chromatograph was also equipped with an Agilent PLgel 5-micron mixed-C 300×7.5 mm column. The chromatograph was equipped with a refractive index detector. Similar equipment was used for CDA except that an OligoPore 300×7.5 mm column was between the guard column and the mixed-C column. The absolute molecular weight was determined by measurement of the output of the GPC with a Wyatt Technology Tristar Multi-Angle Light Scattering (MALS) detector and a Wyatt Technology Optilab DSP Interferometric Refractometer (RID) and using Wyatt Technology Astra Software for control and calibration. The intensity of the scattered light, measure at 690 nm, is proportional to both sample concentration and molecular weight according to equation 1, where I_{scattered} is the intensity of the scattered light, M is the molecular weight, c is sample concentration, and dn/dc is the specific refractive index of the polymer in the analysis solvent.

I_{scattered} α Mc(dn/dc)² Equation 1

The concentration detector used for this experiment is a refractive index detector (RID). Using the RID, the specific refractive index increment (dn/dc) for the polymer under investigation is determined by performing an integral of the entire signal from an injected sample of known concentration (assuming 100% mass recovery from the GPC column). I_{scattered}, c, and dn/dc are known, so M can be determined. For each monodisperse slice, Mw=Mn, but for the overall distribution Mw and Mn are distinct according to equations 2 and 3.

Mn=Σ(NᵢMᵢ)/ΣNᵢ (number average MW) Equation 2

Mw=Σ(NᵢMᵢ²)/Σ(NᵢMᵢ) (weight average MW) Equation 3

Nᵢ is the number of molecules of weight Mᵢ.

The difference in number average molecular weight of the cellulose acylates in a blend affects the transparency (haze) of a film made by solvent casting the blend. In one aspect of the present invention, the number average molecular weights of the cellulose acylates in the blend are at least about 15,000 g/mol. In one aspect of the present invention, the number average molecular weights of the cellulose acylates in the blend are less than about 40,500 g/mol. In one aspect of the present invention, the number average molecular weights of the cellulose acylates in the blend differ by about 15,000 g/mol to 40,500 g/mol.

In one aspect of the present invention, the number average molecular weights of the cellulose acylates in the blend is at least about 15,000 g/mol and the difference in total Hansen solubility parameter for the cellulose acylates in the blend is no more than 0.35 MPa^{0.5}. In one aspect of the present invention, the number average molecular weights of the cellulose acylates in the blend is less than about 40,500 g/mol and the difference in total Hansen solubility parameter for the cellulose acylates in the blend is no more than 0.35 MPa^{0.5}. In one aspect of the present invention, the number average molecular weights of the cellulose acylates in the blend differ by about 15,000 g/mol to 40,500 g/mol and the difference in total Hansen solubility parameter for the cellulose acylates in the blend is no more than 0.35 MPa^{0.5}.

Dope Preparation

Blends of two or more cellulose acylates are typically prepared by the cellulose acylate resin in a container with a solvent, commonly a 90/10 by weight mixture of methylene chloride and methanol. The sealed container is placed on a roller and mixed until a uniform dope is obtained. Alternatively, the resin and solvent is stirred in a sealed container until a uniform dope is obtained. The dope typically has about 15% solids. The mixing may be up to 24 hours.

Additives

The amount of plasticizer in the composition can vary, depending on the particular plasticizer used, the annealing conditions employed, and the level of Rₜₕ desired. Generally, the plasticizer may be present in the composition in an amount ranging from 2.5 to 25 weight percent based on the total weight of the mixed cellulose ester and the plasticizer. The plasticizer may also be present in the composition in an amount ranging from 5 to 25 weight percent. The plasticizer may also be present in the composition in an amount ranging from 5 to 20 weight percent. The plasticizer may also be present in the composition in an amount ranging from 5 to 15 weight percent.

In one embodiment, the mixed cellulose ester composition can comprise one or more plasticizers which can be selected from at least one of the following: triphenyl phosphate, tricresyl phosphate, cresyldiphenyl phosphate, octyldiphenyl phosphate, diphenylbiphenyl phosphate, trioctyl phosphate, and tributyl phosphate; diethyl phthalate, dimethoxyethyl phthalate, dimethyl phthalate, dioctyl phthalate, dibutyl phthalate, di-2-ethylhexyl phthalate, butylbenzyl phthalate and dibenzyl phthalate; butyl phthalyl butyl glycolate, ethyl phthalyl ethyl glycolate or methyl phthalyl ethyl glycolate; and triethyl citrate, tri-n-butyl citrate, acetyltriethyl citrate, acetyl-tri-n-butyl citrate, and acetyl-tri-n-(2-ethylhexyl)citrate. Plasticizers also include esters of polyols and carboxylic acids, sugar oligomers, and esters of carboxylic acids and sugar oligomers.

In addition to plasticizers, the compositions of the invention may also contain additives such as stabilizers, UV absorbers, antiblocking agents, slip agents, lubricants, pinning agents, dyes, pigments, retardation modifiers, matteing agents, mold release agents, etc.

### EXAMPLES

### Examples 1-5

CTA having a total Hansen solubility parameter of 17.72 was blended in various ratios with CAP 14 having a total Hansen solubility parameter of 18.07. Films were cast, dried to <1.0% residual solvent content, then stretched at Tg +20° C. in the transverse direction at a ratio of 1.3 to 1.0. Data is shown in Table 2.

TABLE 2
Examples 1-5

| | 1 | 2 | 3 | 4 | 5 |
|---|---|---|---|---|---|
| Dope Composition | | | | | |
| CTA, g | 0.00 | 3.45 | 6.90 | 10.35 | 13.80 |
| CAP 14, g | 13.80 | 10.35 | 6.90 | 3.45 | 0.00 |
| Triphenyl Phosphate, g | 1.2 | 1.2 | 1.2 | 1.2 | 1.2 |
| Methylene Chloride, g | 74.37 | 74.37 | 74.37 | 74.37 | 74.37 |
| Methanol, g | 7.63 | 7.63 | 7.63 | 7.63 | 7.63 |
| n-butanol, g | 3.00 | 3.00 | 3.00 | 3.00 | 3.00 |
| Film Composition | | | | | |
| CTA, % | 0.0% | 23.0% | 46.0% | 69.0% | 92.0% |
| CAP 14, % | 92.0% | 69.0% | 46.0% | 23.0% | 0.0% |
| Triphenyl Phosphate, % | 8.0% | 8.0% | 8.0% | 8.0% | 8.0% |
| Cellulose Ester | | | | | |
| Compositon in Film | | | | | |
| CTA, % | 0.0% | 25.0% | 50.0% | 75.0% | 100.0% |
| CAP 14, % | 100.0% | 75.0% | 50.0% | 25.0% | 0.0% |
| Tg, ° C. | 174.4 | 176.4 | 166.2 | 175.5 | 170.0 |
| Re normalized to 60 | 34.1 | 21.3 | 18.5 | 10.8 | 3.3 |
| micron film thickness | | | | | |
| Rth normalized to 60 | −95.1 | −65.9 | −56.5 | −45.6 | −35.0 |
| micron film thickness | | | | | |

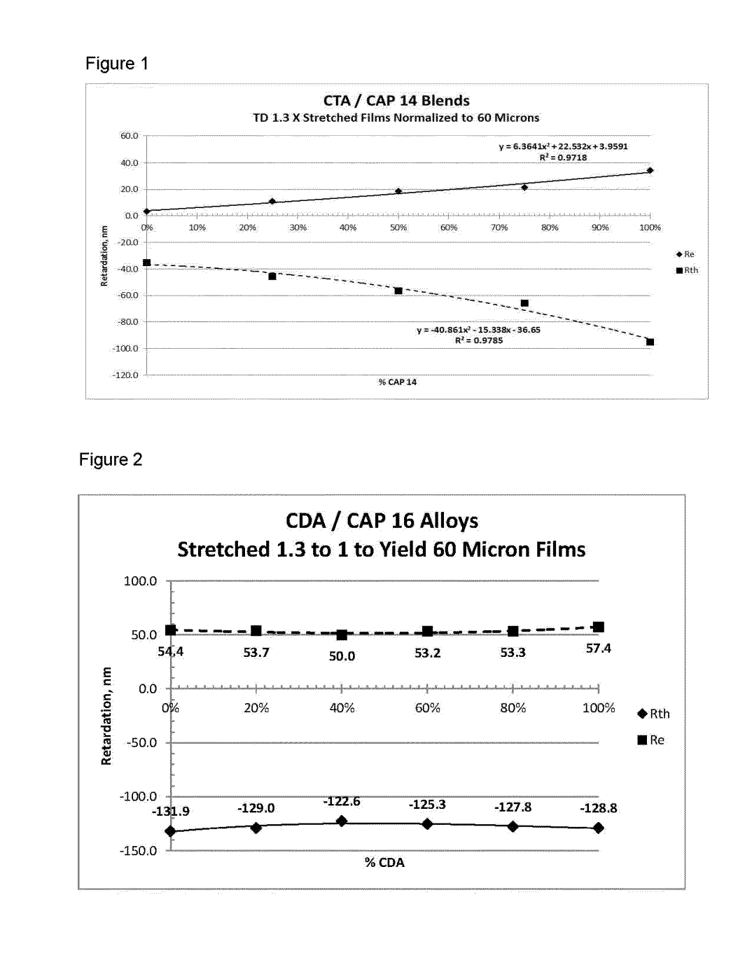

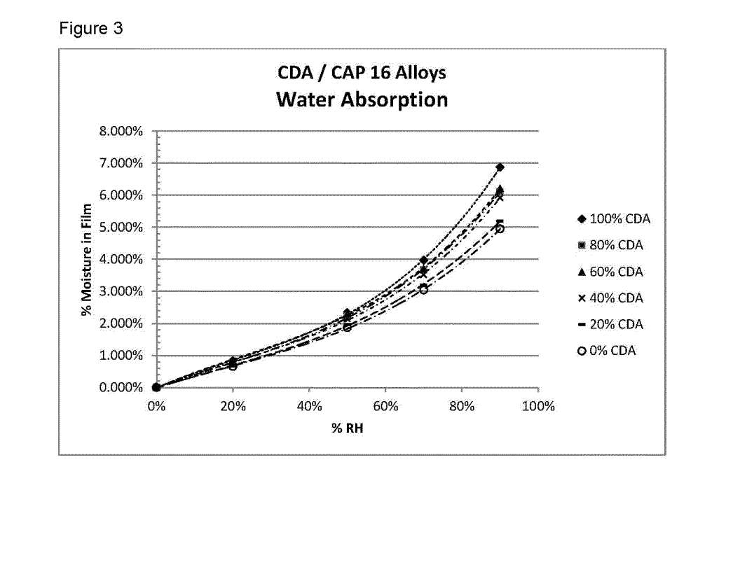

The films were all very transparent. The in plane retardation (Re) and thickness retardation (Rth) data are depicted graphically in FIG. 1. The solvent alloyed mixtures of CTA and CAP 14 exhibit optical properties between those of the pure cellulose esters. This demonstrates that solvent alloying different cellulose esters of similar solubility parameter can be used for optimization of optical, mechanical, or cost properties because of the unexpectedly high transparency of the films made from the blends.

### Experiments 6-8

The following experiment was carried out in which a CDA with total Hansen solubility parameter of 18.62 was blended with a CAP of total Hansen solubility parameter 18.52. Data is shown in Table 3.

TABLE 3
Examples 6-8

| | 1 | 2 | 3 |
|---|---|---|---|
| Dope Composition | | | |
| CDA, g | 30.00 | 27.00 | 24.00 |
| CAP 16, g | 0.00 | 3.00 | 6.00 |
| citric acid, g | 0.10 | 0.10 | 0.10 |
| Triphenyl Phosphate, g | 2.44 | 2.44 | 2.44 |
| Methanol, g | 16.7 | 16.7 | 16.7 |
| n-butanol, g | 5.0 | 5.0 | 5.0 |
| Methylene chloride, g | 145.7 | 145.7 | 145.7 |
| Film Composition | | | |
| CDA, % | 92.19% | 82.97% | 73.76% |
| CAP 16, % | 0.00% | 9.22% | 18.44% |
| citric acid | 0.31% | 0.31% | 0.31% |
| Triphenyl Phosphate | 7.50% | 7.50% | 7.50% |
| Tg (as is) | 148.1 | 147.4 | 145.8 |
| Water absorption, % RH | | | |
| 0 | 0.00 | 0.00 | 0.00 |
| 20 | 0.85 | 0.79 | 0.82 |
| 50 | 2.55 | 2.38 | 2.42 |
| 70 | 4.35 | 4.07 | 4.13 |
| 90 | 7.46 | 6.80 | 6.99 |
| Normalized to 60 microns | | | |
| Re | 45.5 | 45.7 | 44.8 |
| Rth | −133.8 | −121.2 | −118.8 |
| Haze | 0.49 | 0.44 | 0.55 |

The results indicate that solvent alloyed blends of CDA and CAP of solubility parameter within 0.35 MPa^{0.5} make transparent films. The in plane retardation (Re) and thickness retardation (Rth) data are depicted graphically in FIG. 2. The addition of CAP to predominantly CDA films has the advantage of lowering the moisture absorption in the film made from the blend relative to a film of predominantly CDA.

### Examples 9-21

Statistically designed experiments were created using a central composite design with replicated center points. In the initial experiment the relative amounts of CTA and CAP 16 were varied as were the relative amounts of methylene chloride and methanol. Films were hand cast onto glass plates. Retardation data was also collected for pure CTA and CAP 14 for comparison. Retardation values for all of the alloys lie between the values for the pure resins as shown in the table below. All films were held rigid by clips and annealed at 100° C. for 10 minutes and then at 140° C. for 20 minutes to try to approximate commercial films dried in tension at elevated temperatures.

TABLE 4
Examples 9-21

| | | | | | | Thickness |
|---|---|---|---|---|---|---|
| | | | | | | Retardation |
| | | | Methylene | Meth- | | Normalized |
| | CTA, | CAP | Chloride, | anol, | TPP, | to 80 |
| | g | 14, g | g | g | g | microns |
| 9 | 9.66 | 4.14 | 74.37 | 10.63 | 1.2 | −64.2 |
| 10 | 9.66 | 4.14 | 68.00 | 17.00 | 1.2 | −61.1 |
| 11 | 9.66 | 4.14 | 74.37 | 10.63 | 1.2 | −56.9 |
| 12 | 9.66 | 4.14 | 80.75 | 4.25 | 1.2 | |
| 13 | 11.61 | 2.19 | 78.88 | 6.12 | 1.2 | −56.2 |
| 14 | 9.66 | 4.14 | 74.37 | 10.63 | 1.2 | −62.8 |
| 15 | 7.71 | 6.09 | 78.88 | 6.12 | 1.2 | −58.0 |
| 16 | 7.71 | 6.09 | 69.87 | 15.13 | 1.2 | −66.4 |
| 17 | 12.42 | 1.38 | 74.37 | 10.63 | 1.2 | −57.8 |
| 18 | 9.66 | 4.14 | 74.37 | 10.63 | 1.2 | −61.1 |
| 19 | 6.90 | 6.90 | 74.37 | 10.63 | 1.2 | −65.9 |
| 20 | 11.61 | 2.19 | 69.87 | 15.13 | 1.2 | −54.8 |
| 21 | 9.66 | 4.14 | 74.37 | 10.63 | 1.2 | −61.4 |
| Pure | 13.80 | 0.00 | 74.37 | 10.63 | 1.20 | −48.2 |
| CTA | | | | | | |
| Pure | 0.00 | 13.80 | 74.37 | 10.63 | 1.20 | −71.0 |
| CAP | | | | | | |

The amounts shown are in grams, but because the total weight was 100 g, the values are also equal to weight percent. Example 12 did not make a good film despite several attempts, but with careful control of the solvent evaporation rate, we were able to make good quality films in the other runs. Retardation data was also collected for pure CTA and CAP 14 for comparison. Retardation values for all of the alloys lie between the values for the pure resins. All films were held rigid by clips and annealed at 100° C. for 10 minutes and then at 140° C. for 20 minutes to try to approximate commercial films dried in tension at elevated temperatures.

Regression modeling indicated that Example 11 (a center point replicate) was an outlier. When this point was excluded, an R² of 0.928 was obtained. The final equation was as follows:

% Thickness Retardation=693.9072−22.33218*CAP−19.47582*methylene chloride+0.27886*CAP*methylene chloride+0.1264*methylene chloride²

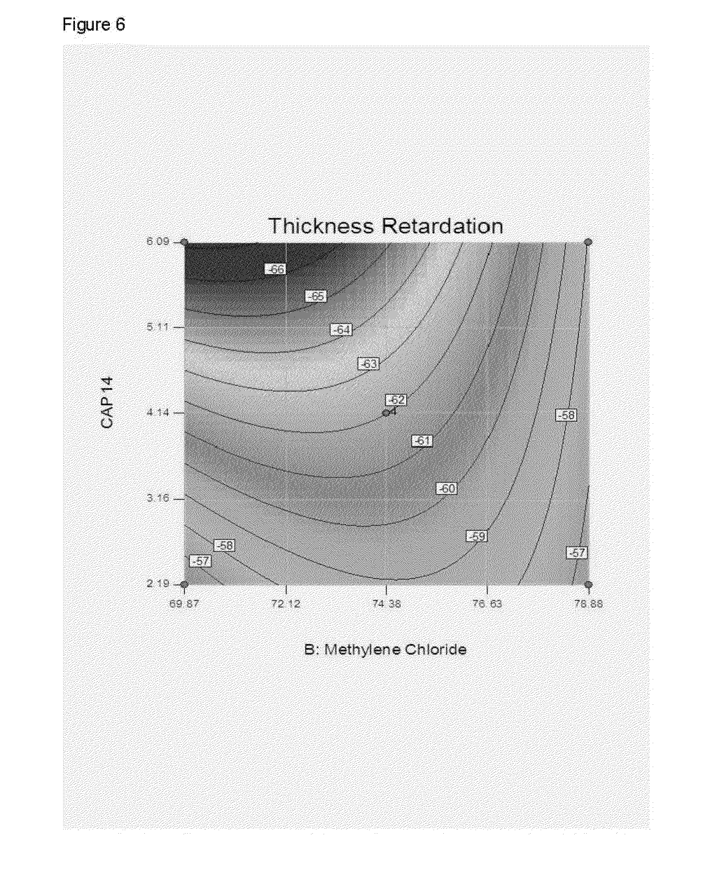

Because the solvent mixture always comprises 85% of the casting solution, only the methylene chloride solvent appears in the equation. Similarly, since triphenyl phosphate (TPP) plasticizer level is fixed, and the total of the plasticizer plus CAP 14 and CTA is always 15%, only CAP14 of the resins appears as a term in the equation. The contour plot described by the equation is shown in FIG. 6.

A second designed experiment was carried out using CTA with CAB 7 as follows:

TABLE 5
Examples 22-34

| | | | | | | Thickness |
|---|---|---|---|---|---|---|
| | | | | | | Retardation |
| | | | Methylene | Meth- | | Normalized |
| | CTA, | CAB | Chloride, | anol, | TPP, | to 80 |
| | g | 7, g | g | g | g | microns |
| 22 | 9.66 | 4.14 | 74.37 | 10.63 | 1.2 | −50.0 |
| 23 | 9.66 | 4.14 | 68.00 | 17.00 | 1.2 | −32.3 |
| 24 | 9.66 | 4.14 | 74.37 | 10.63 | 1.2 | −44.0 |
| 25 | 9.66 | 4.14 | 80.75 | 4.25 | 1.2 | −40.7 |
| 26 | 11.61 | 2.19 | 78.88 | 6.12 | 1.2 | −56.3 |
| 27 | 9.66 | 4.14 | 74.37 | 10.63 | 1.2 | −54.7 |
| 28 | 7.71 | 6.09 | 78.88 | 6.12 | 1.2 | −43.8 |
| 29 | 7.71 | 6.09 | 69.87 | 15.13 | 1.2 | −66.9 |
| 30 | 12.42 | 1.38 | 74.37 | 10.63 | 1.2 | −53.2 |
| 31 | 9.66 | 4.14 | 74.37 | 10.63 | 1.2 | −48.6 |
| 32 | 6.90 | 6.90 | 74.37 | 10.63 | 1.2 | −31.8 |
| 33 | 11.61 | 2.19 | 69.87 | 15.13 | 1.2 | −51.5 |
| 34 | 9.66 | 4.14 | 74.37 | 10.63 | 1.2 | −47.0 |
| Pure | 13.80 | 0.00 | 74.37 | 10.63 | 1.2 | −48.2 |
| CTA | | | | | | |
| Pure | 0.00 | 13.80 | 74.37 | 10.63 | 1.2 | −32.9 |
| CAB | | | | | | |

It is interesting that retardation values for many of the alloys are outside the range defined by the values for pure CTA and CAB 7.

Regression modeling gave an R² of 0.7518. Some of the films were slightly hazy. The final equation is as follows:

% Thickness Retardation=1185.29661+3.98451*CAB−32.81374*methylene chloride+0.21530*methylene chloride²

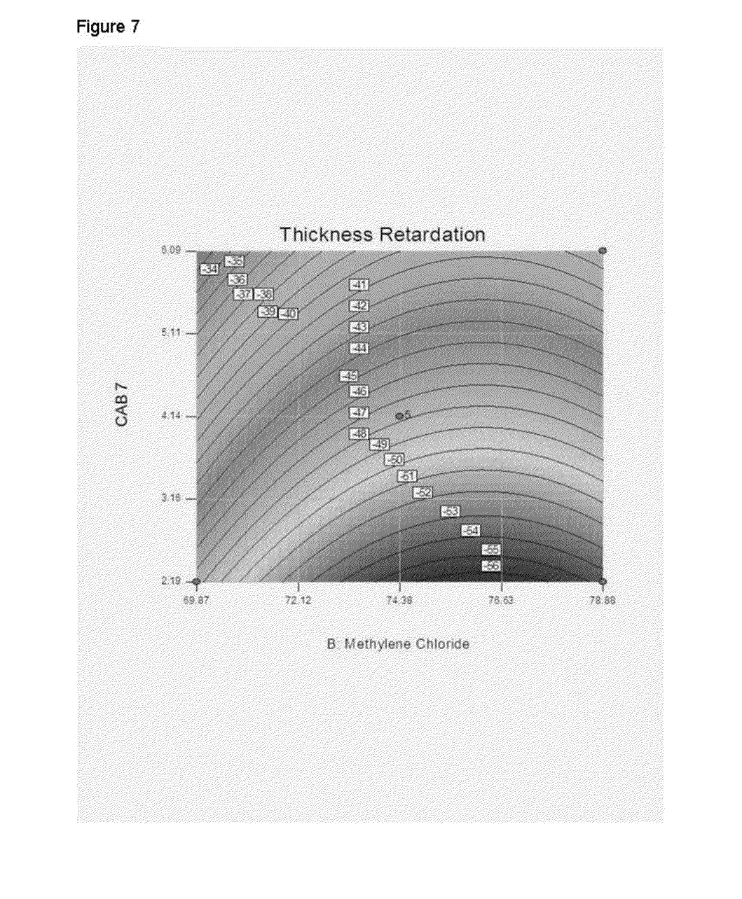

The response surface plot is shown in FIG. 7.

CAP and CAB show sensitivity to high relative humidity that manifests itself as haze in the films. An exhaustive microscopic investigation by optical, scanning electron microscopy, and Raman microscopy determined that the cause of haze under high humidity conditions is void formation. There is no chemical difference in the composition of the material on the surface of the voids and that in the matrix. There appears to be some collapsed material within many of the voids suggesting formation of a “bubble” of a very low solids solution within the drying matrix. This bubble then collapses as the film dries leaving the collapsed polymer and the void. It was theorized that evaporative cooling from the solvent mixture might be causing this phenomenon. Substitution of n-butanol for part of the methanol was found to prevent the haze formation. Based on this, additional designed experiments were conducted.

The next experiment gave the following results:

TABLE 6
Examples 35-47

| | | | | | | | Thickness |
|---|---|---|---|---|---|---|---|
| | | | | | | | Retardation |
| | | | Methylene | Meth- | Buta- | | Normalized |
| | CTA, | CAP | Chloride, | ano, | nol, | TPP, | to 80 |
| | g | 14, g | g | g | g | g | microns |
| 35 | 9.66 | 4.14 | 74.37 | 7.63 | 3.00 | 1.2 | −51.5 |
| 36 | 9.66 | 4.14 | 68.00 | 14.00 | 3.00 | 1.2 | −43.8 |
| 37 | 9.66 | 4.14 | 74.37 | 7.63 | 3.00 | 1.2 | −50.0 |
| 38 | 9.66 | 4.14 | 80.75 | 1.25 | 3.00 | 1.2 | −48.2 |
| 39 | 11.61 | 2.19 | 78.88 | 3.12 | 3.00 | 1.2 | −44.2 |
| 40 | 9.66 | 4.14 | 74.37 | 7.63 | 3.00 | 1.2 | −44.4 |
| 41 | 7.71 | 6.09 | 78.88 | 3.12 | 3.00 | 1.2 | −52.7 |
| 42 | 7.71 | 6.09 | 69.87 | 12.13 | 3.00 | 1.2 | −40.4 |
| 43 | 12.42 | 1.38 | 74.37 | 7.63 | 3.00 | 1.2 | −39.6 |
| 44 | 9.66 | 4.14 | 74.37 | 7.63 | 3.00 | 1.2 | −46.5 |
| 45 | 6.90 | 6.90 | 74.37 | 7.63 | 3.00 | 1.2 | −55.1 |
| 46 | 11.61 | 2.19 | 69.87 | 12.13 | 3.00 | 1.2 | −42.4 |
| 47 | 9.66 | 4.14 | 74.37 | 7.63 | 3.00 | 1.2 | −50.2 |
| Pure | 13.80 | 0.00 | 74.37 | 7.63 | 3.00 | 1.2 | −33.7 |
| CTA | | | | | | | |
| Pure | 0.00 | 13.80 | 74.37 | 7.63 | 3.00 | 1.2 | −84.7 |
| CAP | | | | | | | |

Addition of butanol caused the CTA thickness retardation to become less negative, while that of the CAP 14 became more negative. However, the range of retardation values for the alloys is narrower than when no butanol was used.

Regression modeling gave an R² of 0.5367. The final equation is as follows:

% Thickness Retardation=2.59235−1.81683*CAP−0.56340*methylene chloride

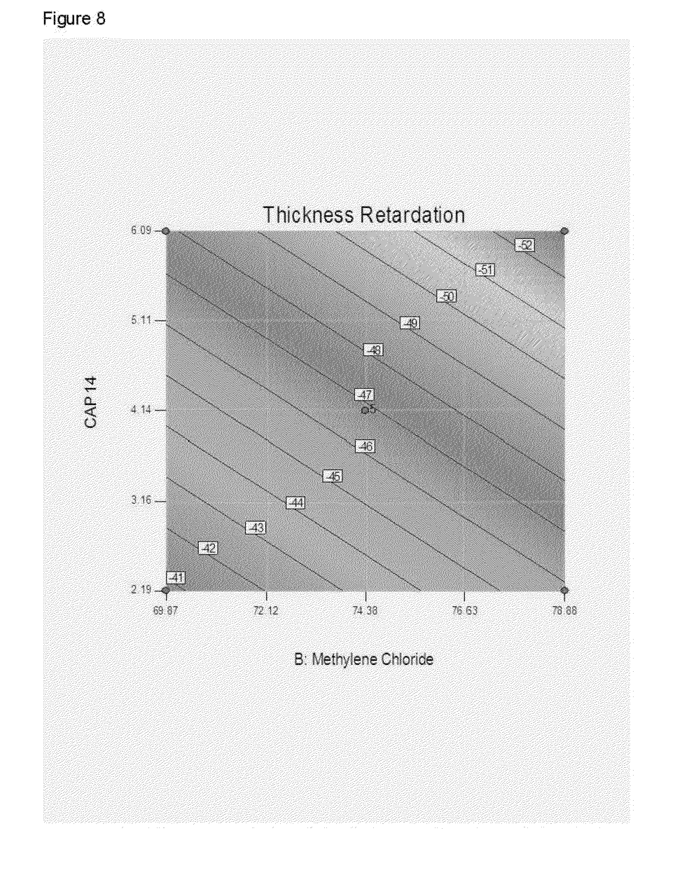

The response surface plot is shown in FIG. 8.

An experiment utilizing butanol with CTA and CAB 7 was conducted as follows:

TABLE 7
Examples 48-60

| | | | | | | | Thickness |
|---|---|---|---|---|---|---|---|
| | | | | | | | Retardation |
| | | | Methylene | Meth- | Buta- | | Normalized |
| | CTA, | CAB | Chloride, | anol, | nol, | TPP, | to 80 |
| | g | 7, g | g | g | g | g | microns |
| 48 | 9.66 | 4.14 | 74.37 | 7.63 | 3.00 | 1.2 | −29.8 |
| 49 | 9.66 | 4.14 | 68.00 | 14.00 | 3.00 | 1.2 | −29.5 |
| 50 | 9.66 | 4.14 | 74.37 | 7.63 | 3.00 | 1.2 | −22.3 |
| 51 | 9.66 | 4.14 | 80.75 | 1.25 | 3.00 | 1.2 | −21.4 |
| 52 | 11.61 | 2.19 | 78.88 | 3.12 | 3.00 | 1.2 | −23.3 |
| 53 | 9.66 | 4.14 | 74.37 | 7.63 | 3.00 | 1.2 | −27.5 |
| 54 | 7.71 | 6.09 | 78.88 | 3.12 | 3.00 | 1.2 | −27.5 |
| 55 | 7.71 | 6.09 | 69.87 | 12.13 | 3.00 | 1.2 | −32.1 |
| 56 | 12.42 | 1.38 | 74.37 | 7.63 | 3.00 | 1.2 | −28.8 |
| 57 | 9.66 | 4.14 | 74.37 | 7.63 | 3.00 | 1.2 | −18.1 |
| 58 | 6.90 | 6.90 | 74.37 | 7.63 | 3.00 | 1.2 | −32.0 |
| 59 | 11.61 | 2.19 | 69.87 | 12.13 | 3.00 | 1.2 | −24.9 |
| 60 | 9.66 | 4.14 | 74.37 | 7.63 | 3.00 | 1.2 | −20.1 |
| Pure | 13.80 | 0.00 | 74.37 | 7.63 | 3.00 | 1.2 | −33.7 |
| CTA | | | | | | | |
| Pure | 0.00 | 13.80 | 74.37 | 7.63 | 3.00 | 1.2 | −22.4 |
| CAB | | | | | | | |

The use of butanol resulted in all films being very clear. Both pure CTA and pure CAB 7 gave retardation values less negative than were seen when no butanol was used. Some values for the alloys gave less negative values than even the CAB 7.

Regression modeling gave an R² of 0.5460. The final equation was:

% Thickness Retardation=−70.22477+5.69148*CAB+0.49072*methylene chloride−0.81004*CAB²

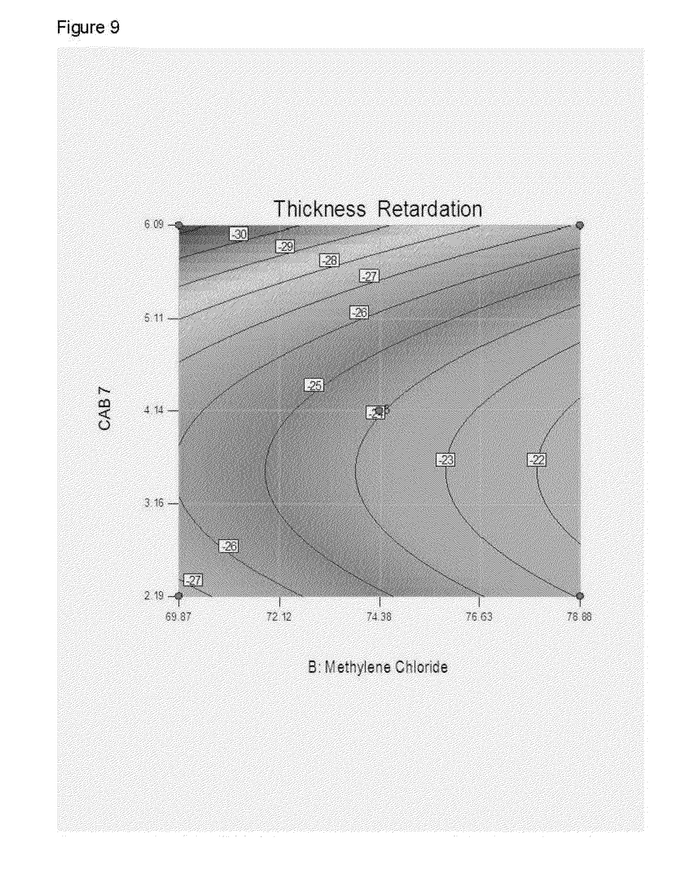

The response surface plot is shown in FIG. 9.

TABLE 8

| | Total Hansen | | | | Clear Films |
|---|---|---|---|---|---|
| | Solubility | | | | When Alloyed |
| Polymer | Parameter | M_{N} | M_{W} | M_{Z} | with CDA |
| CDA | 18.62 | 32,670 | 97,476 | 205,269 | |
| CAP 16 | 18.52 | 44,602 | 107,364 | 190,120 | Yes |
| CAB 10 | 18.67 | 40,265 | 101,496 | 199,657 | Yes |
| CAB 11 | 18.72 | 13,405 | 32,855 | 64,857 | No |

TABLE 9
Data for FIG. 2

| | 1 | 2 | 3 | 4 | 5 | 6 |
|---|---|---|---|---|---|---|
| Dope Composition | | | | | | |
| % in Dope | | | | | | |
| CDA | 15.00% | 12.00% | 9.00% | 6.00% | 3.00% | 0.00% |
| CAP 16 | 0.00% | 3.00% | 6.00% | 9.00% | 12.00% | 15.00% |
| citric acid | 0.05% | 0.05% | 0.05% | 0.05% | 0.05% | 0.05% |
| Triphenyl Phosphate | 1.22% | 1.22% | 1.22% | 1.22% | 1.22% | 1.22% |
| Methanol | 8.37% | 8.37% | 8.37% | 8.37% | 8.37% | 8.37% |
| n-butanol | 2.51% | 2.51% | 2.51% | 2.51% | 2.51% | 2.51% |
| Methylene chloride | 72.85% | 72.85% | 72.85% | 72.85% | 72.85% | 72.85% |
| Film Composition | | | | | | |
| CDA | 92.19% | 73.76% | 55.32% | 36.88% | 18.44% | 0.00% |
| CAP 16 | 0.00% | 18.44% | 36.88% | 55.32% | 73.76% | 92.19% |
| citric acid | 0.31% | 0.31% | 0.31% | 0.31% | 0.31% | 0.31% |
| Triphenyl Phosphate | 7.50% | 7.50% | 7.50% | 7.50% | 7.50% | 7.50% |
| Water absorption, % RH | | | | | | |
| 0% | 0.000% | 0.000% | 0.000% | 0.000% | 0.000% | 0.000% |
| 20% | 0.831% | 0.753% | 0.852% | 0.763% | 0.670% | 0.658% |
| 50% | 2.331% | 2.224% | 2.295% | 2.151% | 1.971% | 1.871% |
| 70% | 3.972% | 3.662% | 3.706% | 3.517% | 3.194% | 3.042% |
| 90% | 6.878% | 6.110% | 6.211% | 5.928% | 5.194% | 4.948% |
| Normalized to 60 microns | | | | | | |
| Re | 57.4 | 53.3 | 53.2 | 50.0 | 53.7 | 54.4 |
| Rth | 128.8 | 127.8 | 125.3 | 122.6 | 129.0 | 131.9 |

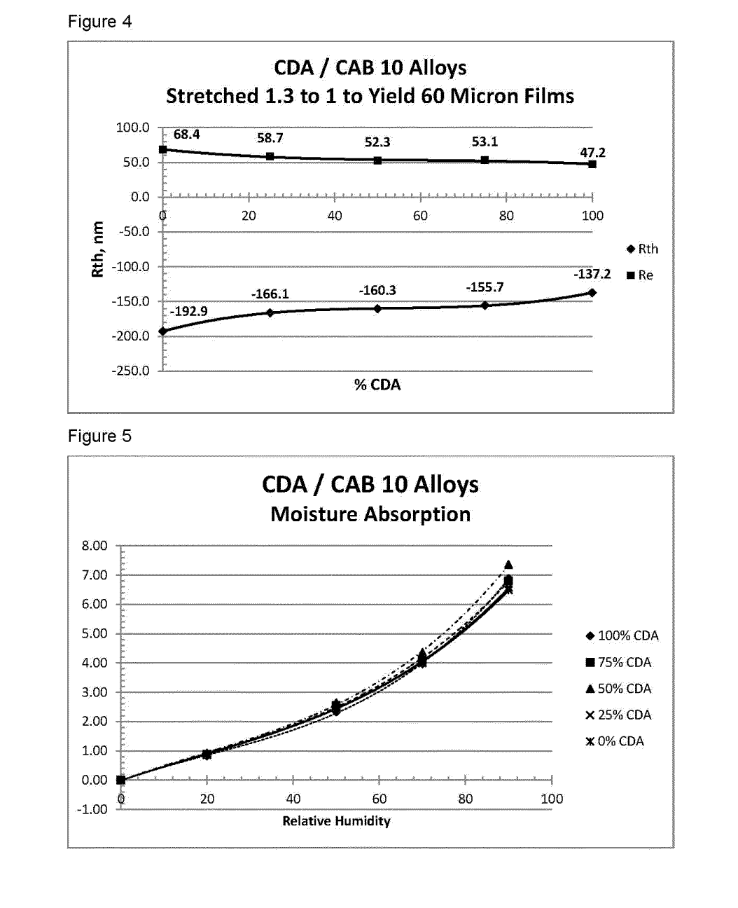

TABLE 10
Data for FIG. 4

| | 1 | 2 | 3 | 4 | 5 |
|---|---|---|---|---|---|
| % in Dope | | | | | |
| CDA | 15.00% | 11.25% | 7.50% | 3.75% | 0.00% |
| CAB 10 | 0.00% | 3.75% | 7.50% | 11.25% | 15.00% |
| Drapex 6.8 | 0.25% | 0.25% | 0.25% | 0.25% | 0.25% |
| citric acid | 0.05% | 0.05% | 0.05% | 0.05% | 0.05% |
| Triphenyl | 1.24% | 1.24% | 1.24% | 1.24% | 1.24% |
| Phosphate | | | | | |
| Methanol | 8.35% | 8.35% | 8.35% | 8.35% | 8.35% |
| n-butanol | 2.50% | 2.50% | 2.50% | 2.50% | 2.50% |
| Methylene | 72.61% | 72.61% | 72.61% | 72.61% | 72.61% |
| chloride | | | | | |
| % in Film | | | | | |
| CDA | 90.69% | 68.02% | 45.34% | 22.67% | 0.00% |
| CAB 10 | 0.00% | 22.67% | 45.34% | 68.02% | 90.69% |
| Drapex 6.8 | 1.51% | 1.51% | 1.51% | 1.51% | 1.51% |
| citric acid | 0.30% | 0.30% | 0.30% | 0.30% | 0.30% |
| Triphenyl | 7.50% | 7.50% | 7.50% | 7.50% | 7.50% |
| Phosphate | | | | | |
| Water | | | | | |
| absorption, | | | | | |
| % RH | | | | | |
| 0 | 0 | 0 | 0 | 0 | 0 |
| 20 | 0.8586 | 0.8806 | 0.9136 | 0.8784 | 0.8632 |
| 50 | 2.49 | 2.552 | 2.639 | 2.511 | 2.485 |
| 70 | 4.005 | 4.130 | 4.361 | 4.023 | 3.998 |
| 90 | 6.469 | 6.804 | 7.364 | 6.577 | 6.486 |
| Normalized | | | | | |
| to 60 | | | | | |
| microns | | | | | |
| Re | 47.2 | 53.1 | 52.3 | 58.7 | 68.4 |
| Rth | −137.2 | −155.7 | −160.3 | −166.1 | −192.9 |

In the drawings and specification, there have been disclosed typical preferred embodiments of the invention and, although specific terms are employed, they are used in a generic and descriptive sense only and not for purposes of limitation, the scope of the invention being set forth in the following claims.

1. A blend comprising:
a first cellulose acylate having a first total Hansen solubility parameter and a first number average molecular weight,
a second cellulose acylate having a second total Hansen solubility parameter and a second number average molecular weight,
wherein the composition is a miscible blend,
wherein the first and second total Hansen solubility parameters differ by no more than 0.35 MPa^{0.5},
wherein the first and second number average molecular weights range from about 15,000 to about 40,500 g/mole, and
wherein at least one of the cellulose acylates comprises a mixed cellulose ester.

2. The blend according to claim 1, wherein the first and second cellulose acylates are independently selected from cellulose acetate, cellulose acetate butyrate and cellulose acetate propionate.

3. The blend according to claim 1, wherein the first cellulose acylate comprises a cellulose acetate and the second cellulose acylate comprises a cellulose acetate butyrate.

4. The blend according to claim 1, wherein the first cellulose acylate comprises a cellulose acetate and the second cellulose acylate comprises a cellulose acetate propionate.

5. The blend according to claim 1, wherein the first cellulose acylate comprises a cellulose acetate butyrate and the second cellulose acylate comprises a cellulose acetate propionate.

6. The blend according to claim 1, wherein the acylate comprises residues of a carboxylic acid having from 1 to 20 carbon atoms.

7. The blend according to claim 6, wherein the acylate comprises an aliphatic carboxylic acid, an aromatic carboxylic acid, a cycloaliphatic carboxylic acid or mixtures thereof.

8. A film comprising a blend, the blend comprising:
a first cellulose acylate having a first total Hansen solubility parameter and a first number average molecular weight,
a second cellulose acylate having a second total Hansen solubility parameter and a second number average molecular weight,
wherein the composition is a miscible blend,
wherein the first and second total Hansen solubility parameters differ by no more than 0.35 MPa^{0.5},
wherein the first and second number average molecular weights range from about 15,000 to about 40,500 g/mole, and
wherein at least one of the cellulose acylates comprises a mixed cellulose ester.

9. The film according to claim 8, wherein the first and second cellulose acylates are independently selected from cellulose acetate, cellulose acetate butyrate and cellulose acetate propionate.

10. The film according to claim 8, wherein the first cellulose acylate comprises a cellulose acetate and the second cellulose acylate comprises a cellulose acetate butyrate.

11. The film according to claim 8, wherein the first cellulose acylate comprises a cellulose acetate and the second cellulose acylate comprises a cellulose acetate propionate.

12. The film according to claim 8, wherein the first cellulose acylate comprises a cellulose acetate butyrate and the second cellulose acylate comprises a cellulose acetate propionate.

13. The film according to claim 8, wherein the acylate comprises an aliphatic carboxylic acid, an aromatic carboxylic acid, a cycloaliphatic carboxylic acid or mixtures thereof.

14. A method of making a film, the method comprising:
dissolving a cellulose acylate having a first total Hansen solubility parameter and a first number average molecular weight, and a second cellulose acylate having a second total Hansen solubility parameter and a second number average molecular weight, in a solvent to form a dope,
casting the dope onto a surface, and
drying the dope to form a film,
wherein the film is a miscible blend of the first and second cellulose acylate,
wherein the first and second total Hansen solubility parameters differ by no more than 0.35 MPa^{0.5}, and
wherein the first and second number average molecular weights range from about 15,000 to about 40,500 g/mole.

15. The method according to claim 14 wherein the first and second cellulose acylates are independently selected from cellulose acetate, cellulose acetate butyrate and cellulose acetate propionate.

16. The method according to claim 14, wherein the first cellulose acylate comprises a cellulose acetate and the second cellulose acylate comprises a cellulose acetate butyrate.

17. The method according to claim 14, wherein the first cellulose acylate comprises a cellulose acetate and the second cellulose acylate comprises a cellulose acetate propionate.

18. The method according to claim 14, wherein the first cellulose acylate comprises a cellulose acetate butyrate and the second cellulose acylate comprises a cellulose acetate propionate.

19. The method according to claim 14, wherein the acylate comprises an aliphatic carboxylic acid, an aromatic carboxylic acid, a cycloaliphatic carboxylic acid or mixtures thereof.

20. The method according to claim 14, where in the solvent comprises methylene chloride, methanol, or mixtures thereof.
